(19) United States
(12) Patent Application Publication
(10) Pub. No.: US 2018/0227971 A1
(43) Pub. Date: Aug. 9, 2018

(54) USER EQUIPMENT AND D2D SIGNAL TRANSMISSION METHOD

(71) Applicant: NTT DOCOMO, INC., Tokyo (JP)

(72) Inventors: Shimpei Yasukawa, Tokyo (JP); Hiroki Harada, Tokyo (JP); Satoshi Nagata, Tokyo (JP); Qun Zhao, Beijing (CN)

(73) Assignee: NTT DOCOMO, INC., Tokyo (JP)

(21) Appl. No.: 15/749,879

(22) PCT Filed: Aug. 12, 2016
(86) PCT No.: PCT/JP2016/073739

§ 371 Date: Feb. 2, 2018

(30) Foreign Application Priority Data
Aug. 13, 2015 (JP) 2015-160000

(51) Int. Cl. H04W 76/14

(52) U.S. Cl. CPC H04W 76/14; H04W 92/18

(57) ABSTRACT

A user equipment of a mobile communication system supporting Device to Device (D2D) communication includes a memory that stores configuration information indicating information on a first resource with which transmission of a D2D signal by the user equipment is allowed and information on a second resource with which transmission of a D2D signal by an other user equipment is allowed, the other user equipment being a specific type of user equipment. The user equipment further includes a transmitter that transmits, based on the configuration information, the D2D signal using the first resource.

### CROSS-REFERENCE TO RELATED APPLICATIONS

This patent application is a national phase application of international application PCT/JP2016/073739 filed Aug. 12, 2016, which claims priority from Japanese Patent Application No. 2015-160000 filed on Aug. 13, 2015. The entire contents of the foregoing applications are hereby incorporated by reference.

### TECHNICAL FIELD

Embodiments of the present invention relate to a technique for transmission of a D2D signal in a mobile communication system supporting D2D.

### BACKGROUND

In Long Term Evolution (LTE) and the successor system of LTE (which is also referred to, for example, as LTE Advanced (LTE-A), Future Radio Access (FRA), 4G, and so forth), Device to Device (D2D) technology has been studied such that units of user equipment directly communicate with each other without going through a radio base station (e.g., Non-Patent Document 1).

D2D allows traffic between the user equipment and the base station to be reduced, and allows communication between units of user equipment to be performed even if the base station becomes unable to communicate at the time of disaster.

D2D is roughly classified into D2D discovery (D2D discovery, which is also referred to as D2D detection) and D2D communication (D2D direct communication). In the following, when D2D communication, D2D discovery, etc., are not particularly distinguished, they are simply referred to as D2D. Furthermore, signals transmitted and received in D2D are referred to as D2D signals.

Furthermore, in 3rd Generation Partnership Project (3GPP), it has been studied to achieve V2X by extending a D2D function. As illustrated in FIG. 1, V2X includes Vehicle to Vehicle (V2V) that means a communication mode performed between an automobile and an automobile; Vehicle to Infrastructure (V2I) that means a communication mode performed between an automobile and a road-side unit (RSU) that is to be installed in a road side; Vehicle to Nomadic device (V2N) that means a communication mode performed between an automobile and a mobile terminal of a driver; Vehicle to Pedestrian (V2P) that means a communication mode performed between an automobile and a mobile terminal of a pedestrian, and so forth.

### PRIOR ART DOCUMENT

### Non-Patent Document

Non-Patent Document 1: “Key drivers for LTE success: Services Evolution,” September 2011, 3GPP, Internet URL: http://www.3gpp.org/ftp/Information/presentations/pr esentations_2011/2011_09_LTE_Asia/2011_LTE-Asia_3GPP_Service_evolution.pdf

Non-Patent Document 2: 3GPP TS 36.213 V12.4.0 (2014-12)

Non-Patent Document 3: 3GPP TS 36.211 V12.6.0 (2015-06)

### SUMMARY

In accordance with embodiments of the invention a user equipment of a mobile communication system supporting Device-to-Device (D2D) communication is disclosed, the user equipment comprising: a memory coupled to a processor, that stores configuration information indicating information on a first resource with which transmission of a D2D signal by the user equipment is allowed and information on a second resource with which transmission of a D2D signal by an other user equipment is allowed, the other user equipment being a specific type of user equipment; and a transmitter that transmits, based on the configuration information, the D2D signal using the first resource.

In some aspects of the user equipment, the configuration information indicates a configuration of one or more uplink subframes and one or more downlink subframes in Time Division Duplexing (TDD), wherein the D2D signal is transmitted by the user equipment through the one or more uplink subframes and the D2D signal is transmitted by the other user equipment through the one or more downlink subframes; or the D2D signal is transmitted by the user equipment through the one or more downlink subframes and the D2D signal is transmitted by the other user equipment through the one or more uplink subframes.

In some aspects of the user equipment, the user equipment includes a receiver that detects the other user equipment by receiving a signal transmitted from the other user equipment, wherein, when the other user equipment is not detected by the receiver, the transmitter transmits the D2D signal using the first resource and the second resource.

In some aspects of the user equipment, the user equipment receives the configuration information from a base station of the mobile communication system or the other user equipment, and the processor stores the configuration information in the memory, and wherein, upon receiving any other configuration information from the other user equipment after receiving the configuration information from the base station, the processor overwrites the configuration information received from the base station with the other configuration information received from the other user equipment.

In accordance with embodiments of the invention a user equipment of a mobile communication system supporting Device-to-Device (D2D) communication is disclosed, the user equipment comprising: a memory coupled to a processor, that stores information on a carrier used for D2D, the carrier being different from a carrier used for communication between a base station of the mobile communication system and the user equipment; and a transmitter that transmits a D2D signal using the carrier used for D2D.

In some aspects of the user equipment, wherein the information on the carrier used for D2D is information on a plurality of carriers for respective service types, and wherein, when a D2D signal corresponding to a specific service type is to be transmitted, the transmitter transmits the D2D signal using, among the plurality of carriers, a carrier corresponding to the specific service type.

In some aspects of the user equipment, wherein the transmitter transmits the D2D signal using transmission power configured without depending on pathloss between the base station of the mobile communication system and the user equipment.

In some aspects of the user equipment, wherein the processor of the user equipment determines, upon receiving location information from a specific device that is identifiable by the user equipment, whether the location information indicates a predetermined location, and wherein, upon detecting that the location information indicates the predetermined location, the processor preferentially receives a signal transmitted from the specific device.

In accordance with embodiments of the invention a Device-to-Device (D2D) signal transmission method to be executed by a user equipment of a mobile communication system supporting D2D is disclosed, the D2D signal transmission method comprising: receiving, from a base station of the mobile communication system, configuration information indicating information on a first resource with which transmission of a D2D signal by the user equipment is allowed and information on a second resource with which transmission of a D2D signal by another user equipment is allowed, the other user equipment being a specific type of user equipment; and transmitting, based on the configuration information, the D2D signal using the first resource.

In accordance with embodiments of the invention a Device-to-Device (D2D) signal transmission method to be executed by a user equipment of a mobile communication system supporting D2D is disclosed, the D2D signal transmission method comprising: receiving information on a carrier used for D2D, the carrier being different from a carrier used for communication between a base station of the mobile communication system and the user equipment, from the base station; and transmitting the D2D signal using the carrier used for D2D.

### BRIEF DESCRIPTION OF DRAWINGS

FIG. 1 is a diagram for illustrating V2X;

FIG. 2A is a diagram for illustrating D2D;

FIG. 2B is a diagram for illustrating D2D;

FIG. 3 is a diagram for illustrating an example of a channel structure used in D2D;

FIG. 4A is a diagram illustrating an example of a structure of a Physical Sidelink Discovery Channel (PSDCH);

FIG. 4B is a diagram illustrating an example of the structure of the PSDCH;

FIG. 5A is a diagram illustrating examples of structures of a Physical Sidelink Control Channel (PSCCH) and a Physical Sidelink Shared Channel (PSSCH);

FIG. 5B is a diagram illustrating example of the structures of the PSCCH and the PSSCH;

FIG. 6A is a diagram illustrating a resource pool configuration;

FIG. 6B is a diagram illustrating a resource pool configuration;

FIG. 7A is a diagram illustrating an example of a structure of a Primary Sidelink Synchronization Signal (PSSS)/Secondary Sidelink Synchronization Signal (SSSS);

FIG. 7B is a diagram illustrating an example of the structure of the PSSS/SSSS;

FIG. 8 is a configuration diagram of a communication system according to one or more embodiments of the present invention;

FIG. 9A is a diagram illustrating Time Division Multiplexing (TDM) for an RSU and user equipment UE;

FIG. 9B is a diagram illustrating the TDM for the RSU and the user equipment UE;

FIG. 10 is a diagram illustrating examples of Time Division Duplexing (TDD) Uplink (UL)/Downlink (DL) configurations;

FIG. 11A is a diagram illustrating an example of a carrier dedicated for V2X;

FIG. 11B is a diagram illustrating an example of the carrier dedicated for V2X;

FIG. 11C is a diagram illustrating an example of the carrier dedicated for V2X;

FIG. 11D is a diagram illustrating an example of the carrier dedicated for V2X;

FIG. 12 is a diagram illustrating an example of the TDD UL/DL configurations;

FIG. 13 is a diagram illustrating connection control to a base station eNB;

FIG. 14 is a diagram illustrating operation example of the RSU;

FIG. 15 is a configuration diagram of the user equipment UE in accordance with one or more embodiments of the invention;

FIG. 16 is a configuration diagram of the base station eNB in accordance with one or more embodiments of the invention; and

FIG. 17 is a hardware (HW) configuration diagram of the user equipment UE and the base station eNB in accordance with one or more embodiments of the invention.

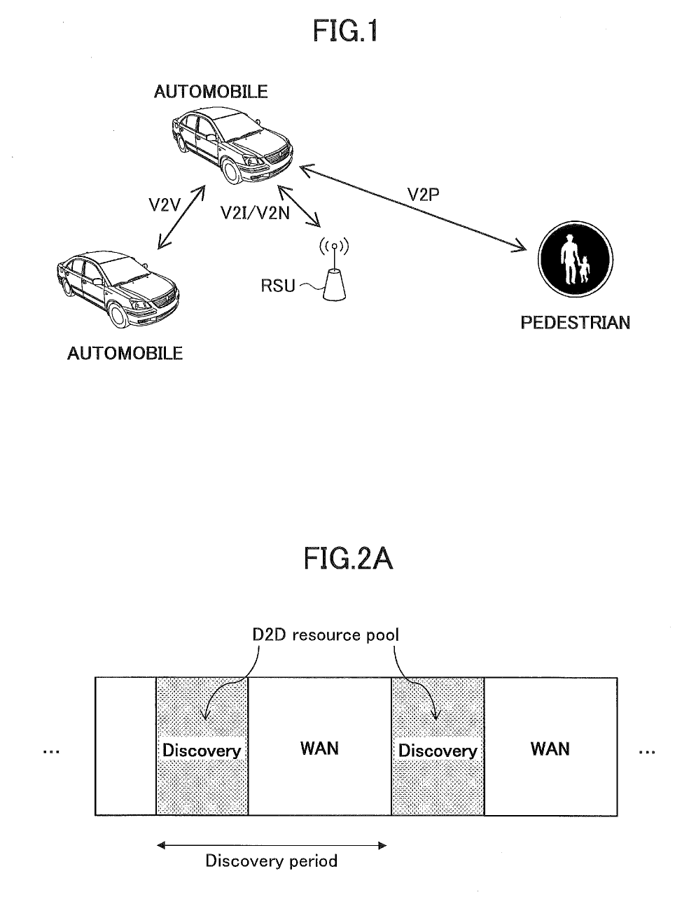

### DETAILED DESCRIPTION

As described above, as transmission nodes in V2X, there are user equipment UE (a vehicle, a person), a road-side unit RSU, and a base station eNB. The road-side unit RSU is implemented as a type of the base station eNB or the user equipment UE. In the following, the road-side unit RSU is referred to as “RSU.” Furthermore, an RSU that is implemented as a type of a base station eNB is referred to as an eNB-type RSU; and a RSU that is implemented as a type of user equipment UE is referred to as a UE-type RSU. In the specification, when simply described as “RSU,” it means that it may be either an eNB-type RSU or a UE-type RSU, unless as otherwise indicated.

When a UE-type RSU is used in V2X, user equipment UE as a mobile terminal and user equipment UE as a RSU coexist. Here, it is considered that the UE-type RSU performs V2X communication with many units of user equipment UE, so that, if usual D2D is applied while handling these as the same types of units of user equipment UE, transmission of D2D signals may not be properly performed, collision, etc., of transmission signals may occur frequently, and sufficient V2X performance may not be obtained.

Furthermore, in V2X, transmission and reception of control signals, for example, for automatic driving of an automobile are to be performed between nodes; however, it is assumed that the number of the nodes per unit area becomes greater than the number of the nodes assumed for existing D2D. When signal transmission is to be performed among such V2X nodes, if half duplex communication within one carrier is applied, as in existing LTE-based D2D, Quality of Service (QoS) reduction and capacity shortage may be caused by increase in collision. In particular, when the UE-type RSU is to be used, the required performance may not be obtained with the framework of existing D2D.

Note that, if it is considered that V2X is a type of D2D, the above-described problem is not limited to V2X, and may occur in D2D in general.

The present invention has been achieved in view of the above-described point. Embodiments of the invention provide, in a mobile communication system supporting D2D, a technique for allowing transmission of D2D signals to be properly performed.

According to one or more embodiments of the present invention, there is provided user equipment of a mobile communication system supporting D2D, the user equipment including a storage unit that retains configuration information indicating information on a first resource with which transmission of a D2D signal by the user equipment is allowed and information on a second resource with which transmission of a D2D signal by specific user equipment is allowed, the specific user equipment being a specific type of user equipment; and a transmitter that transmits, based on the configuration information, the D2D signal using the first resource.

Furthermore, according to embodiments of the present invention, there is provided user equipment of a mobile communication system supporting D2D, the user equipment including a storage unit that retains information on a carrier used for D2D, the carrier being different from a carrier used for communication between a base station of the mobile communication system and the user equipment; and a transmitter that transmits a D2D signal using the carrier used for D2D.

Furthermore, according to embodiments of the present invention, there is provided a D2D signal transmission method to be executed by user equipment of a mobile communication system supporting D2D, the D2D signal transmission method including receiving, from a base station of the mobile communication system, configuration information indicating information on a first resource with which transmission of a D2D signal by the user equipment is allowed and information on a second resource with which transmission of a D2D signal by specific user equipment is allowed, the specific user equipment being a specific type of user equipment; and transmitting, based on the configuration information, the D2D signal using the first resource.

Furthermore, according to embodiments of the present invention, there is provided a D2D signal transmission method to be executed by user equipment of a mobile communication system supporting D2D, the D2D signal transmission method including receiving information on a carrier used for D2D, the carrier being different from a carrier used for communication between a base station of the mobile communication system and the user equipment, from the base station; and transmitting the D2D signal using the carrier used for D2D.

According to embodiments of the present invention, a technique is provided, which is for allowing transmission of D2D signals to be properly performed in a mobile communication system supporting D2D.

In the following, embodiments of the present invention are described by referring to the figures. The embodiments illustrated below are merely examples; and embodiments to which the present invention is applied are not limited to the following. For example, it is assumed that a mobile communication system according to the exemplary embodiments is a system based on a scheme conforming to LTE; however, the present invention is not limited to LTE, and is applicable to another scheme. Furthermore, in the present invention and in the scope of the claims, “LTE” is used in a broad sense that can include a communication scheme corresponding to Rel-12, 13, or on or after that of 3GPP (including 5G).

Furthermore, the described embodiments are intended mainly for V2X; however, a technique according to the present invention is not limited to V2X, and can be broadly applied to D2D in general. In this meaning, “D2D” includes V2X.

In the following, basically, a base station is denoted as “eNB,” and user equipment is denoted as “UE.” The eNB is an abbreviation of “evolved Node B,” and UE is an abbreviation of “User Equipment.” Furthermore, a road-side unit RSU is denoted as “RSU.” Furthermore, a RSU implemented as a type of an eNB is referred to as a eNB-type RSU; and a RSU implemented as a type of user equipment is referred to as a UE-type RSU. In the specification, if it is simply described as “RSU,” it means that it can be either an eNB-type RSU or a UE-type RSU, unless as indicated otherwise. However, it is not limited to these.

(Outline of D2D)

The technology of V2X according to the embodiment is based on the technology of D2D specified in LTE, so that an outline of D2D specified in LTE is described first.

In D2D specified in LTE, each UE executes transmission and reception of signals using a part of uplink resources which have already been specified as resources for uplink signal transmission from the UE to the eNB.

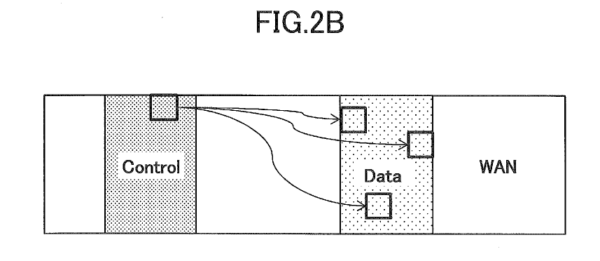

As for “Discovery”, a resource for a Discovery message is reserved for each Discovery period, as illustrated in FIG. 2A; and the UE transmits a Discovery message in the resource pool. More specifically there are Type 1 and Type 2b. In Type 1, the UE autonomously selects a transmission resource from a resource pool. In Type 2b, semi-static resources are allocated by higher layer signaling (e.g., a Radio Resource Control (RRC) signal).

For “Communication,” a resource pool for Control/Data transmission is periodically reserved, as illustrated in FIG. 2B. The transmitting UE reports a resource for Data transmission, etc., to a receiving side by SCI (Sidelink Control Information) with a resource selected from a Control resource pool (SCI resource pool); and transmits Data with the resource for Data transmission. More specifically, for “Communication,” there are Mode 1 and Mode 2. In Mode 1, resources are dynamically allocated by an enhanced Physical Downlink Control Channel ((E)PDCCH) transmitted from an eNB to UE. In Mode 2, UE autonomously selects a transmission resource from the resource pool for Control/Data transmission. As for the resource pool, one that is reported by a System Information Block (SIB) or a predetermined one is to be used.

In LTE, a channel used for “Discovery” is called a PSDCH (Physical Sidelink Discovery Channel); a channel for transmitting control information in “Communication,” such as SCI, is called a PSCCH (Physical Sidelink Control Chanel); and a channel for transmitting data is called a Physical Sidelink Shared Channel (PSSCH) (Non-Patent Document 2).

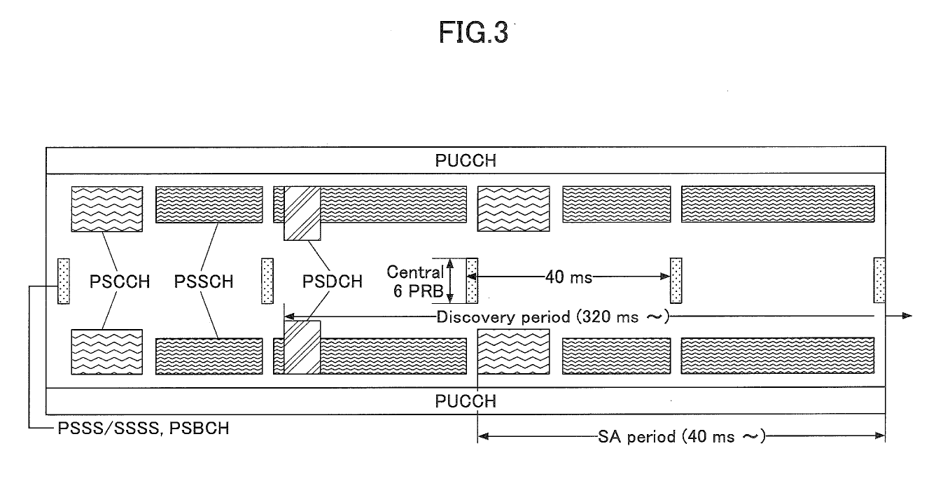

An example of a channel structure of D2D is shown in FIG. 3. As shown in FIG. 3, a PSCCH resource pool used for Communication and a PSSCH resource pool used for Communication are allocated. Furthermore, a PSDCH resource pool used for Discovery is allocated with a period that is longer than a period of the channel of Communication.

Furthermore, PSSS (Primary Sidelink Synchronization) and SSSS (Secondary Sidelink Synchronization) are used as synchronization signals for D2D. Furthermore, for example, a Physical Sidelink Broadcast Channel (PSBCH) for transmitting broadcast information (broadcast information), such as a system band for D2D, a frame number, and resource configuration information, is used for outside coverage operation.

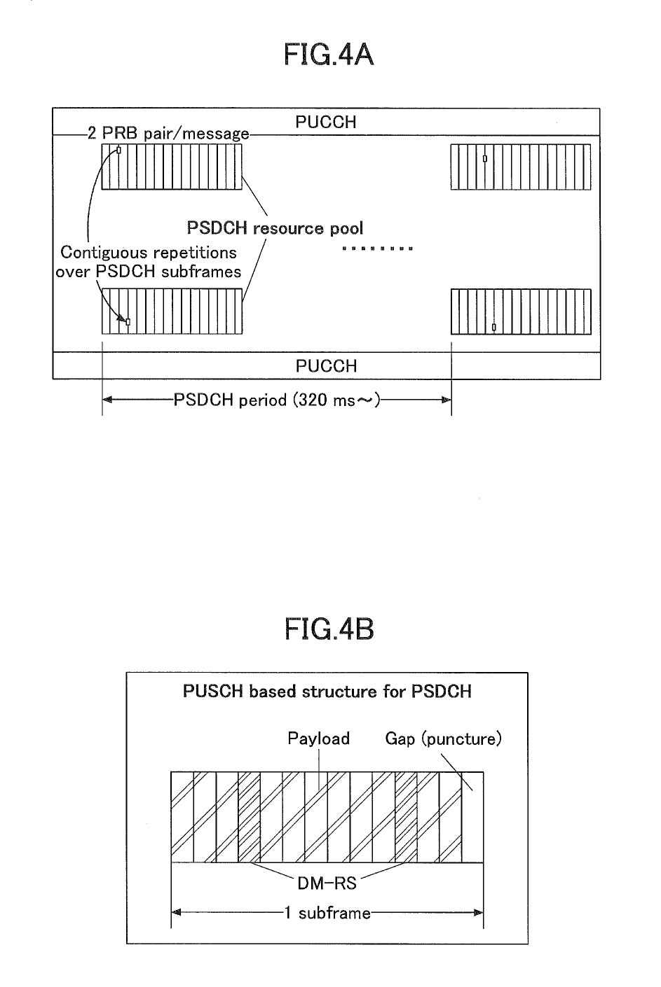

FIG. 4A shows an example of a PSDCH resource pool used for Discovery. Since a resource pool is configured with a bitmap of subframes, the resource pool becomes such that its image is as shown in FIG. 4A. The resource pools for other channels are the same. Furthermore, the PSDCH is repeatedly transmitted (repetition) while being frequency-hopped. The number of times of repetitions can be set to be from 0 to 4, for example. Furthermore, as shown in FIG. 4B, the PSDCH has a structure based on the PUSCH, and it has a structure in which Demodulation Reference Signals (DM-RSs) are inserted.

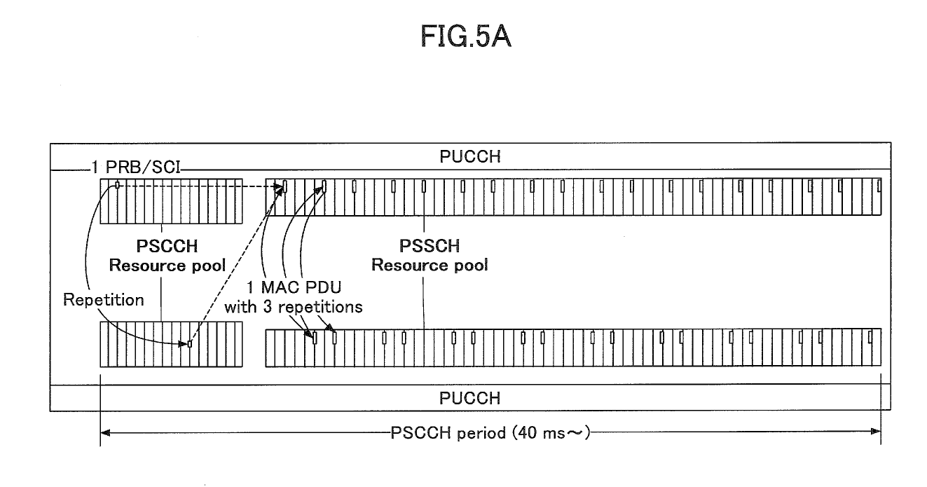

FIG. 5A shows examples of PSCCH and PSSCH resource pools used for “Communication.” As shown in FIG. 5A, the PSCCH is repeatedly transmitted (repetition) once while being frequency-hopped. The PSSCH is repeatedly transmitted (repetition) three times while being frequency-hopped. Furthermore, as shown in FIG. 5B, the PSCCH and the PSSCH respectively have structures based on the PUSCH, and they have structures in which DM-RSs are inserted.

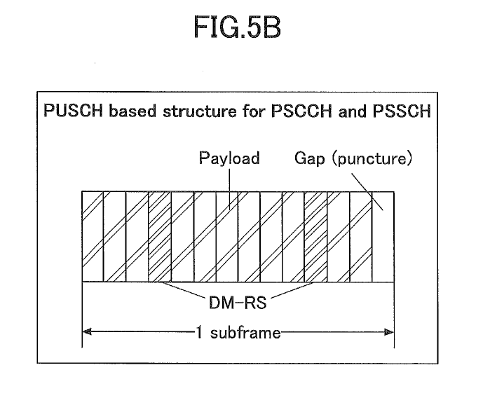

FIGS. 6A and 6B show an example of a resource pool configuration for each of the PSCCH, the PSDCH, and the PSSCH (Mode 2). As illustrated in FIG. 6A, in the time direction, the resource pool can be represented as a subframe bitmap. Furthermore, the bitmap is repeated the number of times of num.repetition. Furthermore, an offset is specified that indicates a start position in each period.

In the frequency direction, contiguous allocation (contiguous) and non-contiguous allocation (non-contiguous) are available. FIG. 6B shows an example of non-contiguous allocation; and, as depicted, the start Physical Resource Block (PRB), the end PRB, and the numbers of PRBs (numPRB) are specified.

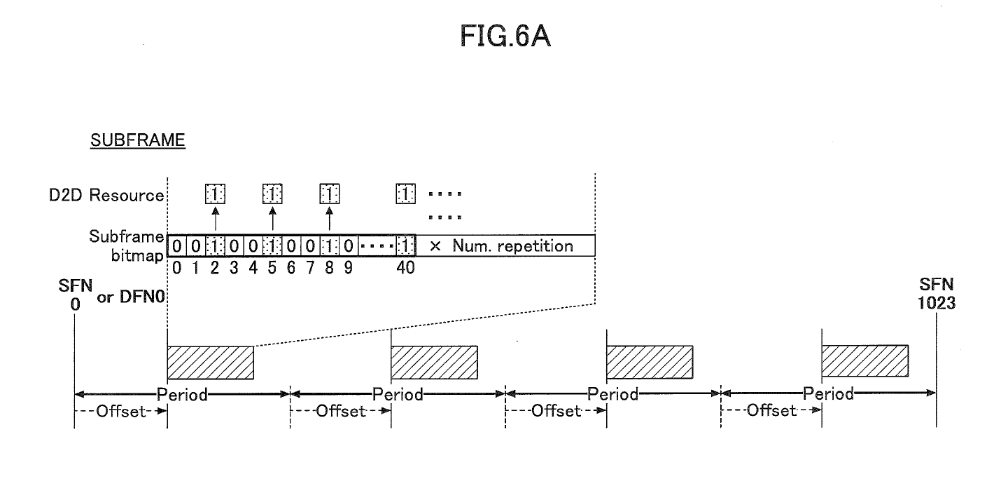

FIG. 7A and FIG. 7B show the PSSS/SSSS. FIG. 7A shows an example of a synchronization subframe in communication. As illustrated in the figure, the PSSS, the SSSS, the DM-RS, and the PSBCH are multiplexed. FIG. 7B shows an example of a synchronization subframe in discovery. As illustrated in the figure, the PSSS and the SSSS are multiplexed.

The PSBCH includes DFN (D2D frame number); a TDD UL-DL configuration; an In-coverage indicator; a system bandwidth; a reserved field, and so forth.

(System configuration)

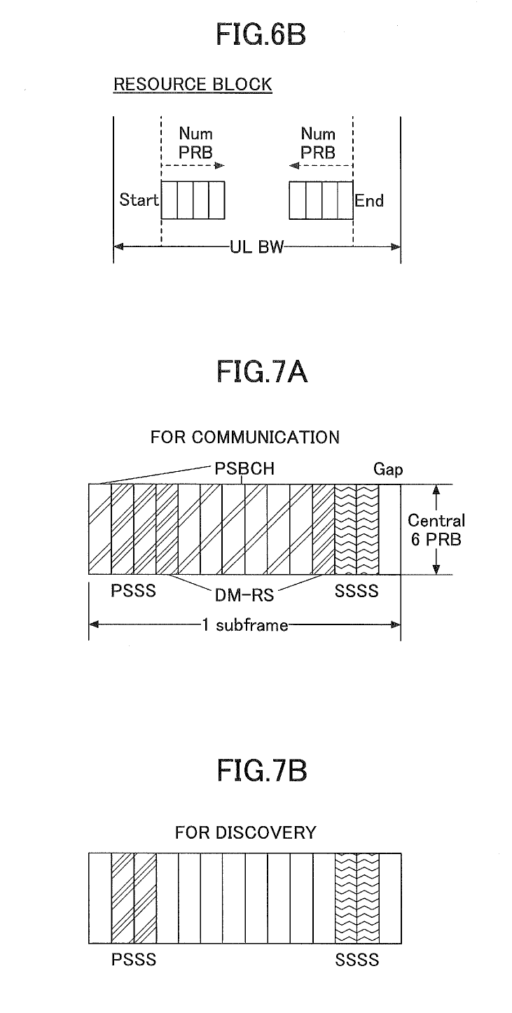

FIG. 8 shows a configuration example of the communication system according to one or more embodiments of the invention. As shown in FIG. 8, the RSU, the UE 1, and UE 2 are provided. Furthermore, the eNB is provided. The eNB is connected to a core network. In the following, when the UE 1 and the UE 2 are not particularly distinguished, they are simply described as UEs.

It is assumed that the RSU illustrated in FIG. 8 is a UE-type RSU; and, for example, the RSU, the UE 1, and the UE 2 belong to the eNB, respectively. However, when V2X communication is performed among the RSU, the UE 1, and the UE 2, these devices may not belong to the eNB.

Furthermore, when the RSU is the eNB-type RSU, the eNB illustrated in FIG. 8 includes the function of the RSU.

Each of the RSU, the UE 1, and the UE 2 illustrated in FIG. 8 includes a cellular communication function, as a UE in LTE; and a D2D function including that for signal transmission/reception in the above-described channels. Furthermore, the RSU, the UE 1, and the UE 2 respectively include functions for executing operation described in the embodiment. Note that, for the cellular communication function and the existing D2D function, only a part of the functions (to the extent that the operation described in the embodiment can be executed) may be included; or all the functions may be included.

Furthermore, the eNB (which includes the eNB-type RSU) includes a cellular communication function, as an eNB in LTE; and a function for allowing D2D (e.g., a function for allocating D2D resources). Furthermore, the eNB (which includes the eNB-type RSU) includes a function for executing operation described in the embodiment. Note that, for the cellular communication function and the function for the existing D2D, only a part of the functions (to the extent that the operation described in the embodiment can be executed) may be included; or all the functions may be included.

(TDM for the UE-type RSU and the UE)

As described above, when the UE-type RSU is to be used in V2X, user equipment UE, as a mobile terminal, and user equipment UE, as a RSU, coexist. Here, if usual D2D is applied while handling these types of user equipment UE as the same types, transmission and reception of signals in V2X may not be appropriately executed.

Thus, in the embodiment, a transmission signal of the UE-type RSU and a transmission signal of the UE are time division multiplexed (TDM: Time Division Multiplexing). In the following, in the description of the “TDM for the UE-type RSU and the UE,” the “RSU” implies the “UE-Type RSU.”

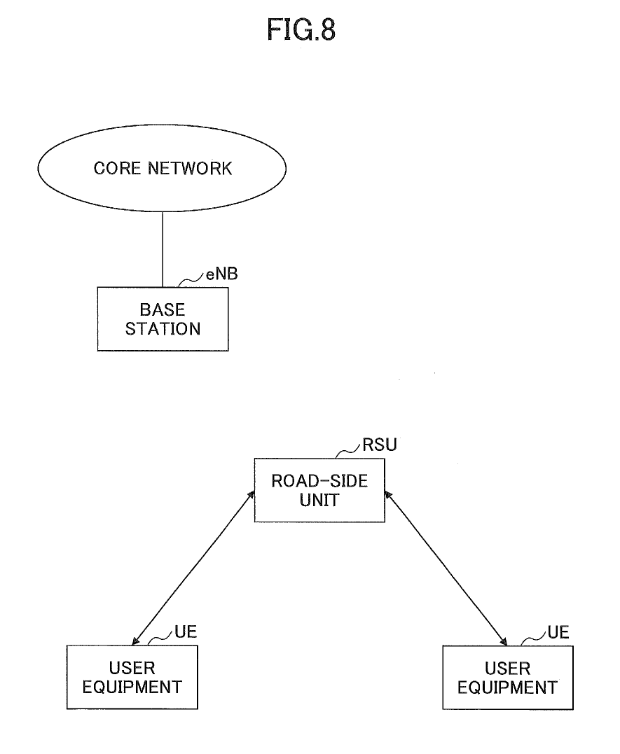

Namely, as illustrated in FIG. 9A, the transmission from the RSU “RSU→x” and the transmission from the UE “UE→x” are time division multiplexed, so that collision of transmission signals does not occur.

Furthermore, as illustrated in FIG. 9B, transmission from the RSU and transmission from the UE may be caused to be overlapped; and the RSU may also be allowed to perform transmission with a time resource for the UE. In the example of FIG. 9B, for example, the UE performs signal transmission only if it can be confirmed, at the time of performing the signal transmission, that signal transmission from the RSU is not being performed (no signal from the RSU is received). Note that the method of identifying the RSU and so forth are described below.

In order to allow the TDM, such as those of shown in FIG. 9A and FIG. 9B, it is necessary that each device (the RSU and the UE) recognizes a time resource with which the own device can perform transmission. For that reason, in the embodiment, a time resource configuration is set in each device; and signal transmission is performed in accordance with the configuration (information of the time during which transmission is permitted) of each device.

The configuration may be preconfigured in each device; or may be configured by the eNB in each device through a broadcast signal, higher layer signaling, and so forth. Furthermore, when the configuration is made by signaling, the RSU may make the configuration with respect to the UE.

Furthermore, a type of signal to which the signal transmission by the TDM, such as those of illustrated in FIG. 9A and FIG. 9B, is not particularly limited; however, for example, it may be applied to data (which corresponds to PSSCH data in D2D), broadcast information (which corresponds to PSBCH information in D2D), and a SLSS signal (which corresponds to a synchronization signal, PSSS/SSSS).

<Specific Example of a Time Resource Configuration>

The time resource configuration in the above-described TDM may be a configuration in fine units, such as units of subframes; or a configuration in more rough units of time. Here, considering the possibility that, even if no synchronization signal can be received by the UE from GPS and/or the base station eNB, rough time synchronization (a subframe level and/or a frame level) can be maintained in the UE with respect to GPS, etc., by not performing D2D transmission (e.g., puncturing) during a specific time period, based on a synchronization reference maintained by the UE, the SLSS and/or another D2D signal/channel (especially, a resource transmitted by the RSU) can be protected, if these are synchronized with GPS and/or the base station eNB. For example, if it is outside the coverage, it can be considered, for example, to use different radio parameters (e.g., configuration of a transmission resource pool) for a GPS synchronous state and a GPS asynchronous state, respectively. Here, the description is made by exemplifying the case where GPS is used as an external synchronization source; however, it is not limited to a satellite positioning system represented by GPS, and it can be applied to a case where an external synchronization source is utilized that can be used outside the coverage, such as radio, television, or Wi-Fi®.

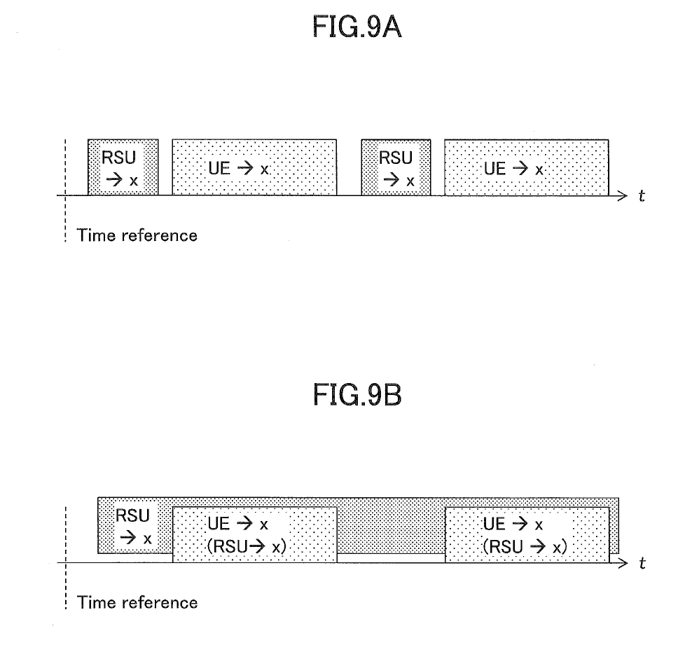

For example, the TDD UL/DL configurations specified in LTE (Non-Patent Document 3) can be used as configurations in units of subframes. FIG. 10 shows an example of the TDD UL/DL configurations (Non-Patent Document 3).

For example, a specific configuration of the configurations shown in FIG. 10 is reported from the eNB to the UE (or the RSU) for V2X; and the UE (RSU) that receives the report performs signal transmission in accordance with the configuration.

As an example, the UE recognizes an uplink (U) subframe in the received configuration as a transmittable subframe; and performs transmission, if there is a signal to be transmitted in the subframe. Furthermore, the RSU recognizes a downlink (D) subframe in the received configuration as a transmittable subframe; and performs transmission, if there is a signal to be transmitted in the subframe. Note that the above-described uplink and downlink may be reversed.

Furthermore, the TDD UL/DL configuration includes a special subframe (special subframe) at a portion for switching UL/DL; and, in the embodiment, the special subframe is for transmission by the RSU, for example. Alternatively, this may be for transmission by the UE. Alternatively, the eNB may set by which device the transmission is to be performed. Alternatively, the special subframe may be blank (not to be used).

Furthermore, by setting, from the eNB to the UE (or the RSU), the resource pool configuration, such as that of shown in FIG. 6A, the TDM configuration may be made. In this case, as an example, the subframe with “0” (or “1”) in the subframe bitmap may be a transmittable subframe of the RSU; and the subframe with “1” (or “0”) may be a transmittable subframe of the UE.

Note that, when the TDM is to be performed and the below-described V2X dedicated carrier is not to be used, the above-described TDM is to be performed, for example, with a time resource other than the time resource for signal transmission/reception with the eNB (cellular communication).

<The Case where the RSU is Not to be Detected>

The time division multiplexing operation of the RSU and the UE in accordance with the above-described TDM assumes the existence of the RSU. If no RSU exists, the UE may perform transmission without considering the transmission resource for the RSU.

Thus, in the embodiment, when the UE is not able to detect any RSU, the UE can use, for transmission, all the time resources that can be used in V2X. For example, when the above-described TDD UL/DL configuration is to be used as the configuration of the time resource, and when no RSU is detected, the UE can use the transmission subframe for the RSU (e.g., DL), as its own transmission subframe.

Note that the UE can detect the presence of the RSU based on the transmission source information included in the synchronization signal transmitted from the RSU; the transmission source information included in the broadcast signal; or the transmission source information included in the data. When the UE detects the RSU, it can be expressed as the UE “exists within the coverage of the RSU.”

In the above-described example, there is no difference in the time resource configuration to be set in the UE between a case where it is within the coverage of the RSU and a case where it is outside the coverage of the RSU. Instead of this, two types of the time resource configurations to be set in the UE may be respectively provided for the case where it is within the coverage of the RSU and for the case where it is outside the coverage of the RSU. In this case, for example, the UE receives a report of the two types of configurations from the eNB (or the RSU) and performs configuration. If it is within the coverage of the RSU, the configuration for within the coverage is used (e.g., the configuration for TDM multiplexing the RSU and the UE); and if it is outside the coverage of the RSU, the configuration for outside the coverage is used (e.g., the configuration that does not include the transmission subframe of the RSU).

Furthermore, when the UE exists within the coverage of the RSU, the RSU configures, to the UE, the configuration for within the coverage of the RSU (e.g., the configuration for TDM multiplexing the RSU and the UE); and the UE uses the configuration while it is within the coverage of the RSU. Furthermore, when the UE goes outside the coverage of the RSU, the configuration for outside the coverage of the RSU, which is configured by the eNB, may be used; or the transmission subframe for the RSU in the configuration for within the coverage of the RSU may be used as the transmission subframe for the UE.

Furthermore, when the configuration including the time resource for RSU transmission is configured, and when it is confirmed that no signal is received from the RSU through the time resource for the RSU transmission (when it is confirmed that the RSU does not transmit any signal), the UE may perform transmission. Note that such an operation is referred to as LBT (Listen Before Talk).

<About Setting of the Time Resource Configuration>

As for setting of the time resource configuration to the UE, there are three types, which are preconfiguring, configuring by the eNB, and configuring by the RSU.

There is a case where, to the UE, the eNB sets the configuration, and, at the same time, the RSU sets the configuration.

For example, upon visiting the eNB for the first time, the UE receives the configuration setting from the eNB; and, after that, the UE enters the coverage of the RSU as it moves, and receives the configuration setting from the RSU. In this case, the UE overwrites, for example, the configuration from the eNB with the configuration from the RSU (namely, the configuration from the eNB is deleted, and the configuration from the RSU is stored). Alternatively, the configuration received from the RSU may be a designation of a subset of the configuration from the eNB. As an example, when the configuration from the eNB is such that the UE is allowed to transmit in subframes A, B, C, and D, the configuration received from the RSU designates the subframes A and C, which are a subset of the subframes A, B, C, and D, as transmittable subframes.

Furthermore, assuming that each UE is preconfigured, when neither the eNB configuration nor the RSU configuration is sent to the UE (e.g., the case where the RSU configuration is overwritten with the eNB configuration), the UE may apply the preconfiguration. Furthermore, when the eNB configuration is not set in the UE (e.g., the case where the RSU configuration is a subset of the eNB configuration), the UE may apply the preconfiguration.

Note that the channel used for reporting the configuration (the radio parameter) from the RSU to the UE is not particularly limited; however, for example, the PSBCH can be used. In this case, for example, the “Reserved field” in the PSBCH can be used. Furthermore, by utilizing a field, such as ProSe Application Code, of the PSDCH (Discovery message), it can also be reported by the PSDCH. In this case, for transmission of the PSDCH, the configuration of the PSDCH resource pool may be reported from the RSU to the UE through the PSBCH.

Furthermore, the transmission resource of the SLSS/PSBCH may be time division multiplexed between the RSU and the UE, so that the UE may identify the RSU/another UE by using the time offset of the SLSS/PSBCH with respect to the reference time. Note that, as the reference time (reference time), the UTC time that can be obtained by the GPS function may be used; or any other time (e.g., the time of the synchronization signal from the eNB) may be used.

For example, assuming that the UE recognizes, by the configuration, etc., that the offset A corresponds to the RSU, upon detecting that the SLSS/PSBCH is received at the time after the offset A from the reference time, the UE can find that the RSU is detected, and can find that the own device is within the coverage of the RSU.

Note that, in the above-described example, the TDM is focused on, and the configuration of the time resource is described; however, the frequency resource may also be configured.

(Use of V2X Dedicated Carrier)

As described above, in V2X, for the communication only using a single carrier, such as the existing LTE-based D2D, it is highly likely that the problem with QoS degradation and capacity shortage occurs. Thus, in the embodiment, a V2X dedicated carrier (V2X dedicated carrier) may be provided.

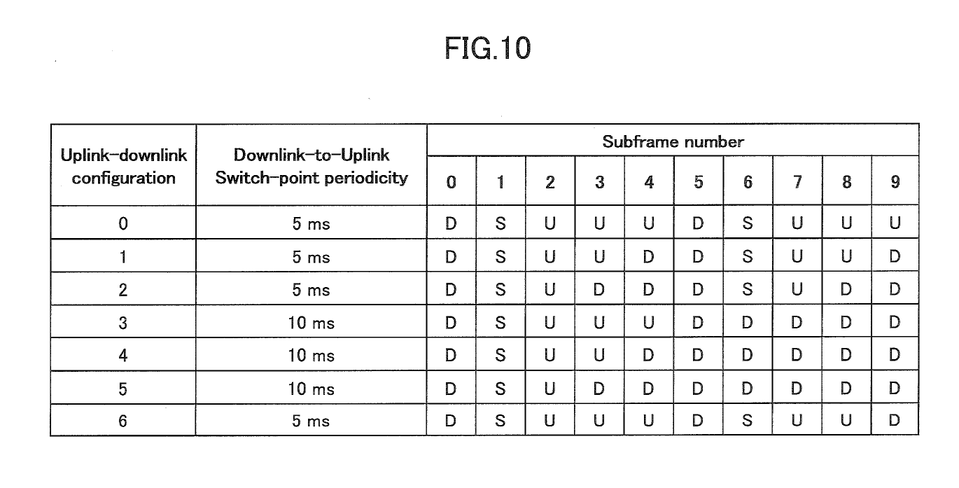

Namely, as illustrated in FIG. 11A, when a cell of the eNB uses the FDD, a carrier for V2X is provided in addition to the UL carrier and the DL carrier. Furthermore, as illustrated in FIG. 11B, for the case of the TDD, a carrier for V2X is provided in addition to the carrier for the TDD.

Note that the usual D2D may be performed in the above-described V2X dedicated carrier. Namely, the above-described V2X dedicated carrier may also be referred to as a carrier for D2D. Furthermore, a dedicated carrier for usual D2D other than V2X and the V2X dedicated carrier may be separately provided.

The configuration of the V2X dedicated carrier with respect to the UE/UE-type RSU may be preconfigured, or may be configured with a broadcast signal, a RRC signal, etc., from the eNB (which includes the eNB-type RSU).

If the V2X dedicated carrier is preconfigured for the UE/UE-type RSU, it is not necessary for the UE/UE-type RSU to receive the broadcast signal, etc., from the eNB/eNB-type RSU to configure the V2X dedicated carrier, so that it is not necessary to monitor downlink signals from the eNB/eNB-type RSU.

Furthermore, as illustrated in FIG. 11C, dedicated carriers may be configured for the RSU and the UE, respectively. In this case, an association between the carriers (e.g., information that the RSU uses the carrier A and the UE uses the carrier B) may be preconfigured for the RSU and the UE; or may be configured through the broadcast signal, the RRC signal, etc., from the eNB/eNB-type RSU.

Furthermore, as illustrated in FIG. 11D, a dedicated carrier for the RSU and dedicated carriers for the UE for respective types of services may be provided. In this case, as an example, a configuration may be made such that the carrier A is for the RSU, the carrier B is for safety usage (safety usage), and the carrier C is for usage other than safety. For example, for transmitting a signal for safety usage (e.g., when an automobile (UE) transmits a warning signal), the UE that receives such a configuration of the carriers (the UE retaining the information on the carriers) performs signal transmission using the carrier B. At this time, a carrier for transmitting the synchronization signal, the broadcast signal, etc., from the eNB may be determined; and a parameter for synchronization with one or more other carriers (e.g., the offset), a radio parameter, and so forth may be configured by using the carrier. In this manner, the number of the downlink carriers to be monitored by the UE among multiple V2X carriers can be reduced; and, at the same time, V2X dedicated or V2X resources can be maximized.

By performing V2X using a dedicated carrier, instead of the UL resource used in usual D2D, signal transmission can be properly performed, an increase in UL interference can be prevented, and performance deterioration of the DL communication caused by a failure of UL transmission (UCI, etc.) can be prevented.

When the V2X dedicated carrier is to be provided, as in FIGS. 11A, 11B, 11C, and 11D, the resource pool configuration, which indicates which frequency resources in the carrier (in the band) can be used and which time resources can be used, may be configured by the eNB/eNB-type RSU for the UE/UE-type RSU.

As shown in FIG. 6A, for the resource pool configuration, the configuration for the existing D2D may be used; or a configuration dedicated for V2X may be used. Furthermore, for the time resource (the TDM between the RSU and the UE), the TDD DL/UL configuration may be utilized, as described above.

Furthermore, as illustrated in FIG. 11D, when the carriers are respectively provided for the service types, as an example, designation of a carrier for each service type and a resource pool for each service type (for each carrier) are configured for each UE. The configuration may be made through the broadcast signal from the eNB/eNB-type RSU; or may be made through higher layer signaling (e.g., the RRC signal).

Then, for example, when signal transmission of a certain service type is to be performed (e.g., when a packet provided with a specific transmission destination ID (L2 ID, etc.) is to be transmitted), the UE to which the configuration is made performs the signal transmission using the resource in the carrier and in the resource pool corresponding to the service type. Note that a carrier for each service type and a resource pool for each service type (for each carrier) may be preconfigured for the UE. Furthermore, the service type may be identified by a dedicated identifier, in addition to the transmission destination ID.

Furthermore, when the UE itself corresponds to a specific service type, the UE determines its own service type; and when V2X signal transmission is to be performed, the UE performs the signal transmission using the resource in the carrier and in the resource pool corresponding to the service type.

Note that, in V2X, when resource allocation is to be performed from the eNB/eNB-type RSU (e.g., mode 1 communication), the resource allocation may be performed with cross carriers by switching among a plurality of carriers by adding carrier identifiers to the resource allocation signal from the eNB/eNB-type RSU. Furthermore, in particular, when the resource allocation is to be performed with the (E)PDCCH, a search space and/or a subframe to which the allocation information is to be mapped is divided for respective carriers, and the UE may identify the carrier based on the search space and/or the subframe in which the allocation information is detected. Note that, for the search space and/or the subframe for each carrier, a configuration is made from the eNB/eNB-type RSU to the UE by higher layer signaling, etc. Furthermore, in this case, the UE may report, to the eNB/eNB-type RSU, the BSR for D2D (for V2X) by adding a carrier identifier or a service type.

(Addition of UL to the TDD UL/DL Configuration)

In order to increase communication resources for V2X, instead of providing the V2X dedicated carrier or in addition to providing the V2X dedicated carrier, as described above, a configuration obtained by adding a UL subframe to the existing TDD UL/DL configuration may be newly provided in the TDD cell, and this may be configured for the UE/UE-type RSU.

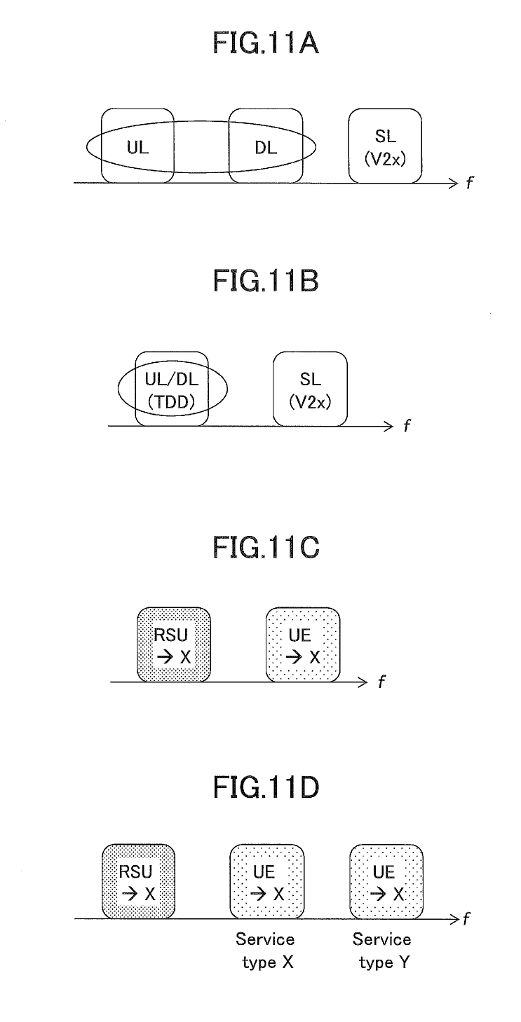

FIG. 12 shows an example of the configuration. In FIG. 12, the configuration “0” is an existing configuration, and the configuration “x” is a new configuration. Note that, even if the configuration “x” is to be set, the normal cellular UL signal transmission can be performed. For example, when the configuration “x” is to be used, a resource pool configuration indicating which subframe of the UL subframes of the configuration “x” is available for D2D (V2X) is set by the eNB/eNB-type RSU in the UE/UE-type RSU; and the UE/UE-type RSU executes D2D (V2X) using the resource pool. The resource pool configuration may include information for identifying resources available for the RSU and resources available for the UE so as to implement the above-described TDM between the RSU and the UE.

Furthermore, it is assumed that the configuration “x” is to be set, for example, by the eNB/eNB-type RSU in an area where V2X is more frequently performed compared to the normal cellular communication; and, in such a situation, it can be considered that most of the UL subframes are configured for D2D (V2X).

In particular, in the subframe of the configuration “x” that is changed from that of the existing TDD configuration (D, S→U, U), only D2D (V2X) may be performed, without performing cellular UL/DL transmission and reception. The reason is that the existing TDD configuration is designed considering UL/DL resource allocation and the HARQ time line, so that if UL/DL transmission and reception are performed with the subframe that is changed from that of the existing TDD configuration, the resource allocation and the HARQ control may not be normally executed.

Furthermore, the cell (eNB/eNB-type RSU) that assigns a special configuration, such as the configuration “x,” to the UE may not permit random access and a RRC connection for the belonging UE/UE-type RSU; and may only permit the downlink broadcast or multicast, and the Sidelink communication (D2D, V2X).

Such an operation may be implemented, for example, by reporting to the UE/UE-type RSU, through the broadcast signal, by the eNB/eNB-type RSU, that the RRC connection is unavailable but the V2X communication is allowed; or, upon detecting that a special configuration, such as the configuration “x,” is assigned, the UE/UE-type RSU may perform an operation not to attempt to establish a RRC connection.

In one DL subframe of the configuration “x” of FIG. 12, the UE receives a synchronization signal, a broadcast signal, etc., from the eNB/eNB-type RSU. Instead of this, in such a cell (carrier) for setting the configuration “x,” the synchronization signal, the broadcast signal, etc., may not be transmitted. In this case, the UE receives the synchronization signal, the broadcast signal, etc., from another carrier (cell). In this case, as a special configuration, a configuration may be set such that all the subframes are for UL. In this manner, D2D/V2X can be performed without overhead of DL resources.

When the configuration “x” shown in FIG. 12 is to be set, the DL subframe occurs only in a cycle of 10 ms. Accordingly, when the configuration “x” is set, the eNB/eNB-type RSU may only transmit the synchronization signal (PSS/SSS) once per 10 ms, which is normally transmitted in a cycle of 5 ms. In view of such a point, when a configuration is set in which the number of UL subframes is increased, such as the configuration “x,” the requirement on synchronization accuracy may be relaxed.

Furthermore, by associating the synchronization timing with the GPS timing (UTC time) in advance, the UE may establish time synchronization by GPS, and may use the PSS/SSS only for a part of cell detection and frequency synchronization.

<About Transmission Power Control>

The transmission power of the UE is usually controlled based on the pathloss between the

UE and the eNB. For example, when the UE is close to the eNB, the transmission power is low; and, when the UE is far from the eNB (e.g., cell edge), the transmission power is high.

However, in V2X, it is not preferable that the transmission power of the UE changes depending on whether it is closer to or far from the eNB (pathloss). Thus, in the embodiment, transmission power corresponding to the communication range (signal transmission distance), which is assumed by the UE/UE-type RSU in V2X, is to be set for the UE/UE-type RSU, for example. This configuration may be made in the UE/UE-type RSU in advance; or the configuration may be made through a broadcast signal, higher layer signaling, etc., from the eNB/eNB-type RSU. Furthermore, the transmission power may be set in the UE by the UE-type RSU.

The transmission power configured as described above is independent from the pathloss between the UE and the eNB, so that V2X can be performed with stable transmission power. This can be implemented, for example, by autonomously (without signaling) setting, by the UE, the value of alpha (weighting factor) of the fractional transmit power control (TPC) to be 0 in the carrier for performing V2X (e.g., the above-described V2X dedicated carrier). Furthermore, only the maximum transmission power may be specified in the UE capability or the UE power class.

With such a configuration, the UE that executes V2X can ensure a sufficient communication range, even if it is located at the center of the cell.

Furthermore, in order to avoid transmitting synchronization signals inside and outside the coverage and performing unnecessary transmission power control, for the carrier for performing V2X (e.g., the V2X dedicated carrier), the Null value may be specified as a reference carrier (the carrier to be measured) for RSRP measurement or for pathloss estimation. Namely, neither the RSRP measurement nor the pathloss estimation may be performed for the V2X dedicated carrier.

Furthermore, in order to change the transmission power and/or the SLSS transmission condition between the UE-type RSU and the UE, a parameter for each UE type (the transmission power and/or the SLSS transmission condition) may be distributed through broadcast information; a parameter for each UE type may be preconfigured; or a parameter for each UE type may be individually configured through higher layer signaling, such as RRC.

(About the eNB Connection Control)

As described above, in an area where V2X is supposed to be executed, the eNB/eNB-type RSU configures, for example, the V2X dedicated carrier for the UE/UE-type RSU; or sets a special TDD configuration, in which one or more UL subframes are added, for the UE/UE-type RSU.

However, it is not preferable that the above-described configuration is made for a general UE that is not provided with the function for executing V2X.

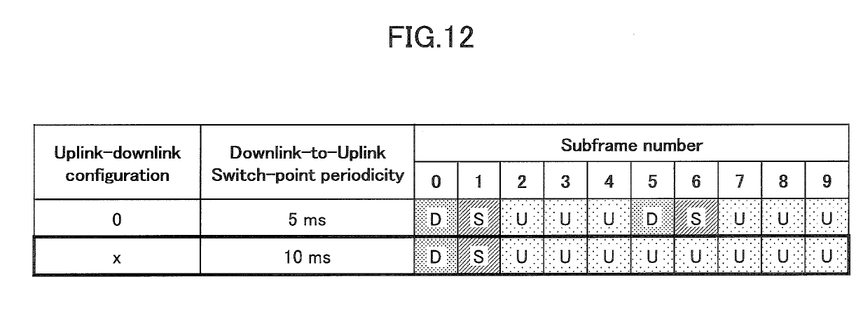

Thus, in the embodiment, the eNB/eNB-type RSU is provided with a function for limiting UEs with which the RRC connections can be established (random access is allowed). Specifically, as shown in FIG. 13, the eNB/eNB-type RSU limits UEs with which the RRC connections are to be established by reporting details of the restriction (access restriction information) through broadcast information (Master Information Block (MIB), SIB), or the RRC signaling. The restriction of the RRC connection to the UE can be made, for example, for each carrier.

Note that, the “RRC connection” here implies, as an example, that various configurations (data bearer configuration, measurement configuration, etc.) are made for the UE through RRC Connection Reconfiguration, after the UE detects the cell (PSS/SSS reception), receives the MIB, and performs random access, etc.

For example, the eNB/eNB-type RSU determines whether the UE to be connected is a UE provided with the capability of V2X based on one or more of the UE category, the UE capability, the Access class, and the authentication information received from the UE prior to performing the RRC Connection Reconfiguration; and, when the UE is provided with the capability of V2X, establishment of the RRC connection is allowed (continues the RRC connection process), and, for the UE that is not provided with the capability of V2X, establishment of the RRC connection is disallowed (prompt the UE to transition to another cell) by returning, for example, an error and/or rejection message.

Furthermore, a process may be performed such that, for example, the access restriction information (e.g., information indicating that only the V2X UE can access) may be included in the MIB or the SIB to be received prior to performing the random access by the UE detecting the cell (e.g., the cell of the V2X carrier); and, if the UE itself that receives the MIB/SIB is a V2X UE, the UE executes an RRC connection process including the random access, and if it is not the V2X UE, starts searching for another cell.

Furthermore, for example, when it belongs to the eNB forming a general cell, the UE transmits its capability information (e.g., information indicating that the V2X function is not included) to the eNB; receives information (black list) indicating a cell/carrier with which establishment of the RRC connection is not possible (or not possible to visit); and, upon detecting a cell (e.g., the cell of the V2X carrier)/carrier described in the list, determines not to establish the RRC connection (or visit) to it. The black list includes identification information, cell IDs, etc., of the carriers for which the RRC connections (or visits) are not to be established.

Furthermore, for example, when it belongs to the eNB/eNB-type RSU forming the cell of the V2X carrier, the UE receives, from the eNB, information (black list) indicating cells with which establishment of the RRC connections is not possible (or not possible to visit); and, upon detecting a general cell, it may determine not to visit the cell in accordance with the black list.

By performing the control, such as that described above, for example, capacity shortage can be avoided, which is caused by connecting to the eNB-type RSU by the general UE. Conversely, it can also be avoided that the V2X UE connects to a small cell, etc., and that handover frequently occurs.

Note that, the radio parameter for V2X and the radio parameter for any other communication may be independently reported from the RSU through a broadcast signal (DL or SL). Furthermore, for each resource pool, a UE type that is allowed to transmit may be reported. In this manner, while allowing D2D other than V2X, the radio resource for D2D can be restricted.

(RSU Identification Method)

As described above, for implementing V2X, there are cases where the UE is required to recognize the existence of the RSU. Furthermore, especially for a UE-type RSU, the eNB may not make a special configuration/resource allocation, etc., to the RSU, unless it can identify whether the UE is the RSU or not. Thus, in the following, it is described that the RSU transmits which signal, so that the RSU can be identified by the UE/eNB, and so forth.

<UE-Type RSU>

First, the UE-type RSU is described. The UE-type RSU is a terminal including a function as a UE in LTE.

The UE-type RSU retains, for example, the UE capability corresponding to the RSU, the terminal ID, or preconfiguration/authentication information, etc.; and is provided with a function for reporting, to the eNB, information indicating that the own device is the RSU (e.g., the UE capability, the terminal ID, etc.). The eNB (or a device at the core network side that receives information from the eNB) can identify that the UE is the RSU based on the information.

Furthermore, the UE-type RSU may have a special address (e.g., a L1 or L2 address in a range of L1 or L2 addresses exclusive of any other UEs); and is provided with a function for transmitting, for example, SCI, a MAC header, etc., including the address. The receiving UE/eNB that receives a packet including the SCI, the MAC header, etc., can identify, based on the address, that the transmission source UE is the RSU, in units of packets.

Furthermore, the UE-type RSU may be provided with a function for transmitting a special synchronization signal sequence (e.g., a synchronization signal sequence exclusive of any other UEs (identifiable)). By being provided with such a function, another UE identifies the UE-type RSU and prioritizes the UE-type RSU in the synchronization operation, so that the stability of the synchronization can be enhanced. Namely, when a certain UE receives synchronization signals from the UE-type RSU and a general UE, respectively, the synchronization signal received from the UE-type RSU can be preferentially used.

Furthermore, the UE-type RSU may be provided with a function for transmitting special broadcast information. For example, the UE-type RSU transmits broadcast information that is not the SFN transmission in addition to the PSBCH, so that the UE receiving the broadcast information can recognize the existence of the UE-type RSU, and can obtain the broadcast information of the UE-type RSU.

Furthermore, the UE-type RSU may use a special DM-RS sequence (the DM-RS sequence that is different from that of a general UE). In this manner, for example, when the resource pool is shared between the UE and the UE-type RSU, interference randomization effect can be obtained.

Furthermore, as described above, the UE-type RSU is provided with a function for transmitting D2D signals (synchronization signals, broadcast, data, etc.) using special carriers (e.g., the V2X dedicated carrier for the RSU) and special time/frequency resources (e.g., the resource pool with time resources for the RSU). In this manner, when the UE-type RSU performs signal transmission with the RSU resource, the UE receiving the signal from the UE-type RSU can easily detect the existence of the surrounding RSU based on the power level by configuring the RSU resource in advance.

Furthermore, as for the UE-type RSU, the type of the UE (which is the RSU) may be reported from the core network (e.g., MME) to the eNB. In this manner, for example, the eNB can recognize the type of the UE corresponding to a contract (e.g., the fact that the user concludes the contract with a communication carrier to use the UE as the RSU, etc.).

<eNB-Type RSU>

Next, the eNB-type RSU is described. The eNB-type RSU is a device including a function as an eNB in LTE.

The eNB-type RSU is provided with a function for transmitting a special synchronization signal, a special Discovery signal, a special broadcast signal (MIB/SIM), and special higher layer control information. Here, “special” means that the signal is different from a signal in a general eNB, and that it can be identified as the RSU at the receiving side.

As an example, the eNB-type RSU may be provided with a function for transmitting the SIB including information indicating that it has the function of the RSU; and the UE receiving the SIB can determine that the device itself belongs to the cell of the eNB-type RSU soon after detecting the cell. Namely, the UE can recognize the RSU without depending on the downlink carrier frequency, and can change the synchronization and connection operation.

Furthermore, the eNB-type RSU may be provided with a function for performing transmission using a special carrier (e.g., the V2X carrier). In this case, by configuring for the UE that the special carrier is the carrier of the RSU, the UE can recognize the eNB-type RSU at high speed. In particular, it suffices for the UE that is to be connected only to the eNB-type RSU (e.g., a V2X dedicated UE) to search only for the carrier, so that the search operation can be simplified.

Furthermore, the eNB-type RSU may be provided with a function for reporting, to another eNB-type RSU, its own coordinate information and/or a resource configuration for D2D using backhaul signaling (e.g., the X2 interface). By being provided with such a function, interference coordination between the eNB-type RSUs can be allowed.

Furthermore, the information on the eNB-type RSU may be reported, by another eNB (which includes a eNB-type RSU) in the vicinity, to a UE belonging to a cell of the other eNB. The reporting is performed, for example, by the SIB or the RRC message. Furthermore, the information to be reported is, for example, a carrier frequency of the eNB-type RSU, the cell ID, the timing synchronization offset, the configuration of the Discovery signal, and so forth. Consequently, the UE that receives the report can determine that the eNB-type RSU exists in the vicinity; and, for example, the UE desiring to perform V2X can quickly perform an operation to transfer to the cell of the eNB-type cell.

Furthermore, the other eNB may report, to the subordinate UE, the location information (coordinate information) of the eNB-type RSU in the vicinity. By receiving the report of the coordinate information, the UE can limit the eNB-type RSUs to be detected. For example, the UE can perform operation for detecting only an eNB-type RSU existing in an area where V2X is desired to be performed. Consequently, the UE can efficiently detect the RSU without connecting to the RSU.

<About Location Information Reporting by the RSU>

The reporting of the above-described location information may be performed by the RSU itself (which may be the UE type or the eNB type).

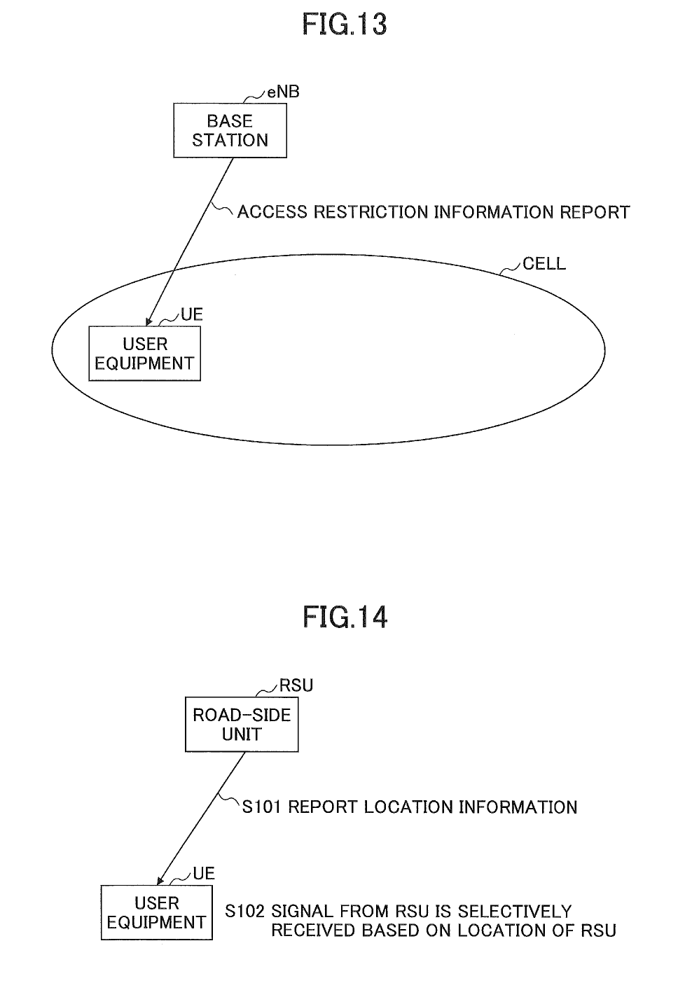

An operation example of this case is described by referring to FIG. 14. For example, the RSU reports the location information using broadcast information, a broadcast message (e.g., PSBCH), higher layer signaling, etc. (step S101), so that the UE can recognize that the transmission source is the RSU (e.g., using the identification information).

By the report in step S101, the UE recognizes reception of position information from the RSU. Then, the UE selectively (preferentially) receives the signal from the RSU based on the location of the RSU (step S102). For example, when the UE (example: automobile) recognizes that the RSU exists near the UE or on a deriving route of the UE (predetermined position), the UE preferentially receives the signal from the RSU over the signal from the other transmission source. To preferentially receive the signal from the RSU over the signal from the other transmission source implies that, for example, a decoding operation for the radio resource used by the RSU for transmission is performed at a high frequency, and decoding operation for another resource is performed at a low frequency.

Consequently, for example, when the RSU performs distribution/signal control of the traffic condition around an intersection, the UE (automobile) can quickly detects the RSU, and accident prevention/traffic optimization can be achieved by selectively communicating with the RSU.

Note that the RSU may reduce the overhead by transmitting only a part of the location information at a lower layer. Namely, since the range in which the signal from the RSU can be received is several hundred meters, the location of about 10 m grid in the range of about several km is to be reported, for example. If the range and the granularity are at this degree, the location information can be reported with a small number of bits. Such transmission of a subset of the location information at the lower layer is not limited to the RSU, and it may be performed by the UE.

(Device Configuration)

<Configuration Example of UE>

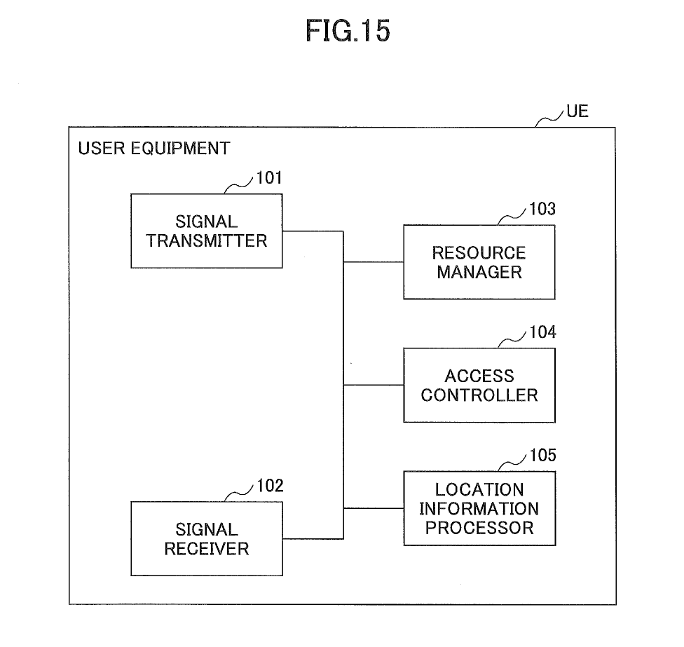

FIG. 15 shows a functional configuration diagram of the UE according to the embodiment. The UE illustrated in FIG. 15 is a UE that can be either the UE (the UE which is not the RSU) for performing V2X described in the embodiment, or the UE-type RSU; however, for example, it may include only the function of the UE (the UE which is not the RSU) or only the function of the UE-type RSU. Furthermore, the UE illustrated in FIG. 15 is capable of executing all the process of the UE (which includes the UE-type RSU) described above. However, a part of the processes of the UE (which includes the UE-type RSU) described above may be executable. In the following, main functions are described.

As shown in FIG. 15, the UE includes a signal transmitter 101; a signal receiver 102; a resource manager 103; an access controller 104; and a location information processor 105. Note that FIG. 15 only shows, in the user equipment UE, functional units that are particularly related to the embodiment of the present invention; and at least functions, which are not depicted, for executing operation conforming to LTE are also included. Furthermore, the functional configuration illustrated in FIG. 15 is merely an example. The functional division and names of functional units may be any division and names, provided that the operation according to the embodiment can be executed.

The signal transmitter 101 includes a function for generating various types of physical layer signals from one or more higher layer signals to be transmitted from the user equipment UE, and for wirelessly transmitting them. Furthermore, the signal transmitter 101 includes a transmission function for D2D (including V2X); and a transmission function for the cellular communication.

The signal receiver 102 includes a function for wirelessly receiving various types of signals from another UE (which includes the UE-type RSU) or the eNB (which includes the eNB-type RSU), and for retrieving a higher layer signal from a received physical layer signal. The signal receiver 102 includes a reception function for D2D (including V2X); and a reception function for the cellular communication.

The resource manager 103 includes a storage unit for retaining at least resource information related to transmission of a signal of a UE. The resource information is the resource information for the TDM, the carrier information, the resource pool information, the TDD configuration information, and so forth, which are described above. The resource information may be pre-configured, or may be information received from the eNB/RSU. Furthermore, the resource manager 103 performs the above-described process related to the resource, such as overwriting of the configuration information from the RSU.

The signal transmitter 101 performs transmission of a D2D signal, etc., using the resource information stored in the resource manager 103.

The access controller 104 determines whether it is allowed to connect to (or to visit) the eNB (or the RSU), for example, based on a signal received from the eNB (or the RSU); and if it is possible to connect (or to visit), establishes a connection (or visits), and if it is not possible, executes control, such as searching for another cell.

The location information processor 105 receives location information from the RSU and determines whether the location information corresponds to a predetermined location; and if it corresponds, executes control so that a signal from the RSU is to be preferentially received. Furthermore, when the UE functions as the RSU, the location information processor 105 transmits its own location information with a transmission method such that it is possible to identify, in another UE, that the own device is the RSU.

<Configuration Example of eNB>

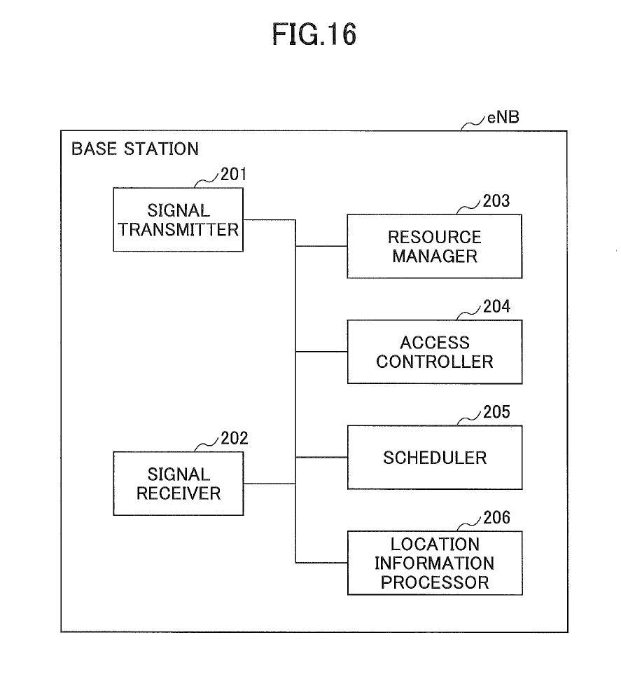

FIG. 16 shows a functional configuration diagram of the eNB according to the embodiment. The eNB shown in FIG. 16 is the eNB which can be either eNB (the eNB that is not the RSU) or the eNB-type RSU; however, for example, it may only include the function of the eNB (the eNB which is not the RSU), or may only include the function of the eNB-type RSU. Furthermore, the eNB illustrated in FIG. 16 is capable of executing all the processes of the eNB (which includes the eNB-type RSU). In the following, main functions are described.

As shown in FIG. 16, the eNB includes a signal transmitter 201; a signal receiver 202; a resource manager 203; an access controller 204; and a scheduler 205, and a location information processor 206. Note that FIG. 16 only shows, in the eNB, functional units that are particularly related to the embodiment of the present invention; and at least functions, which are not depicted, for operating as an eNB in a mobile communication system conforming to LTE may also be included. Furthermore, the functional configuration illustrated in FIG. 16 is merely an example. The functional division and names of functional units may be any division and names, provided that the operation according to the embodiment can be executed.

The signal transmitter 201 includes a function for generating various types of physical layer signals from one or more higher layer signals to be transmitted from the eNB, and for wirelessly transmitting them. The signal receiver 202 includes a function for wirelessly receiving various types of signals from a UE (which includes a UE-type RSU), and for retrieving a higher layer signal from a received physical layer signal.

The resource manager 203 includes a storage unit for retaining at least resource information related to transmission of a signal of a UE. The resource information is the resource information for the TDM, the carrier information, the resource pool information, the TDD configuration information, and so forth, which are described above. The resource information may be information that is pre-configured in the UE, or may be information that is configured for the UE.

The access controller 204 transmits the access restriction information, and performs an operation, such as limiting UEs to be connected to (or served by) the eNB. The scheduler 205 executes scheduling (resource allocation) for a UE to perform signal transmission/reception. The location information processor 206 performs, when the eNB functions as the RSU, transmission of its own location information.

<Hardware Configuration>

The block diagram (FIG. 15 and FIG. 16) used for describing the above-described embodiment shows blocks in units of functions. These functional blocks (components) are implemented by any combination of hardware and/or software. Namely, each functional block may be implemented by a single device that is physically and/or logically coupled; or may be implemented two or more devices by directly and/or indirectly (e.g., wired and/or wireless) connecting the two or more physically and/or logically separated devices.

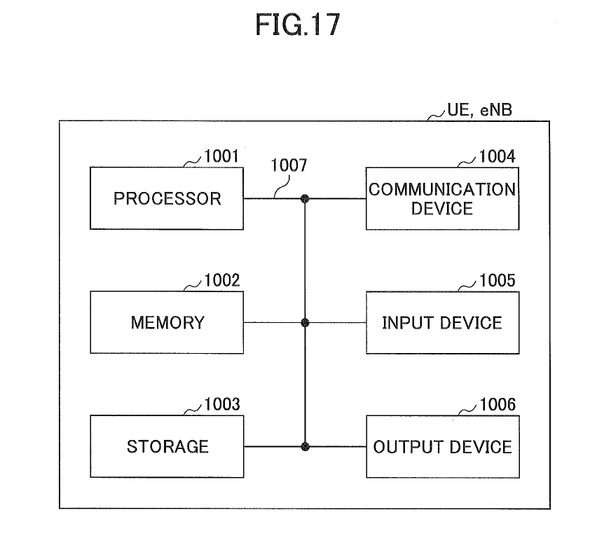

For example, the base station eNB (which includes the eNB-type RSU) according to the embodiment of the present invention may function as a computer for performing the process according to the embodiment of the present invention. FIG. 17 is a diagram showing an example of a hardware configuration of each of the base station eNB and the user equipment UE according to the embodiment of the present invention. Each of the above-described base station eNB and the user equipment UE may be physically configured as a computer device including a processor 1001; a memory 1002; a storage 1003; a communication device 1004; an input device 1005; an output device 1006; a bus 1007, and so forth.

Note that, in the following description, the term “device” can be replaced with a circuit, an apparatus, a unit, and so forth. The hardware configuration of each of the base station eNB and the user equipment UE may be configured to include one or more devices that are depicted; or may be configured without including a part of the devices.

Each function in the base station eNB and the user equipment UE is implemented by loading predetermined software (program) on hardware, such as the processor 1001 and the memory 1002, so that the processor 1001 performs an operation to control communication by the communication device 1004, and reading and/or writing data in the memory 1002 and the storage 1003.

The processor 1001, for example, processes the operating system to control the entire computer. The processor 1001 may be formed of a central processing unit (CPU: Central Processing Unit) including an interface with a peripheral device, a control device, a processing device, a register, and so forth. For example, the signal transmitter 101, the signal receiver 102, the resource manager 103, the access controller 104, and the location information processor 105 of the user equipment UE may be implemented by the processor 1001. Furthermore, the signal transmitter 201, the signal receiver 202, the resource manager 203, the access controller 204, and the scheduler 205 and the location information processor 206 of the base station eNB may be implemented by the processor 1001.

Furthermore, the processor 1001 reads out a program (program code), a software module, or data from the storage 1003 and/or the communication device 1004 to the memory 1002; and executes various types of processes in accordance with these. As the program, a program is used, which is for causing a computer to execute at least a part of the operation described in the above-described embodiment. For example, the signal transmitter 101, signal receiver 102, the resource manager 103, the access controller 104, and the location information processor 105 may be implemented by a control program that is stored in the memory 1002 and operated by the processor 1001; and the other functional blocks may be implemented similarly. Furthermore, the signal transmitter 201, signal receiver 202, the resource manager 203, the access controller 204, and the scheduler 205 and the location information processor 206 may be implemented by a control program that is stored in the memory 1002 and operated by the processor 1001; and the other functional blocks may be implemented similarly. It is described that the above-described processes are executed by one processor 1001; however, these may be executed simultaneously or sequentially by two or more processors 1001. The processor 1001 may be implemented by one or more chips. Note that the program may be transmitted from a network through an electric communication line.

The memory 1002 is a computer readable recording medium; and may be formed of, for example, at least one of a ROM (Read Only Memory), an EPROM (Erasable Programmable ROM), an EEPROM (Electrically Erasable Programmable ROM), a RAM (Random Access Memory), and so forth. The memory 1002 is capable of storing a program (program code), a software module, and so forth, which can be executed for implementing the communication method according to the embodiment of the present invention.

The storage 1003 is a computer readable recording medium; and may be formed of, for example, at least one of an optical disk such as a CD-ROM (Compact Disc ROM), a hard disk drive, a flexible disc, a magneto-optical disk (for example, a compact disk, a digital versatile disk, a Blu-ray® disk), a smart card, a flash memory (e.g., a card, a stick, a key drive), Floppy® disk, a magnetic strip, and so forth. The storage 1003 may be referred to as an auxiliary storage device. The above-described storage medium may be, for example, a data base including the memory 1002 and/or the storage 1003, a server, or another suitable medium.

The communication device 1004 is hardware (transmission/reception device) for performing communication between computers through a wired and/or wireless network; and, for example, it is also referred to as a network device, a network controller, a network card, a communication module, and so forth. For example, the signal transmitter 101 and the signal receiver 102 of the user equipment UE may be implemented by the communication device 104. Furthermore, the signal transmitter 201 and the signal receiver 202 may be implemented by the communication device 104.

The input device 1005 is an input device (e.g., a keyboard, a mouse, a microphone, a switch, a button, a sensor, etc.) for receiving an input from outside. The output device 1006 is an output device (e.g., a display, a speaker, a LED lamp, etc.) that performs output to outside. Note that the input device 1005 and the output device 1006 may be integrated (e.g., a touch panel).

Furthermore, the devices, such as the processor 1001 and the memory 1002, are connected by the bus 1007 for communicating information. The bus 1007 may be formed of a single bus; or may be formed of buses that are different among the devices.

Furthermore, the base station eNB and the user equipment UE may be formed to include hardware, such as a microprocessor, a digital signal processor (DSP: Digital Signal Processor), an ASIC (Application Specific Integrated Circuit), a PDL (Programmable Logic Device), and a FPGA (Field Programmable Gate Array); and the hardware may partially or entirely implement each functional block. For example, the processor 1001 may be implemented by at least one of these hardware components.

### Conclusion of the Embodiment

As described above, according to one or more embodiments of the invention, there is provided user equipment of a mobile communication system supporting D2D, the user equipment including a storage unit that retains configuration information indicating information on a first resource with which transmission of a D2D signal by the user equipment is allowed and information on a second resource with which transmission of a D2D signal by specific user equipment is allowed, the specific user equipment being a specific type of user equipment; and a transmitter that transmits, based on the configuration information, the D2D signal using the first resource.

With the above-described configuration, transmission of the D2D signal can be properly performed in the mobile communication system supporting D2D.

The configuration information is, for example, configuration information indicating a configuration of one or more uplink subframes and one or more downlink subframes in TDD, wherein the D2D signal is transmitted by the user equipment through the one or more uplink subframes and the D2D signal is transmitted by the specific user equipment through the one or more downlink subframes; or the D2D signal is transmitted by the user equipment through the one or more downlink subframes and the D2D signal is transmitted by the specific user equipment through the one or more uplink subframes. With this configuration, for example, the existing configuration information can be applied, so that the technique of the present invention can be quickly introduced.

The user equipment may include a receiver that detects the specific user equipment by receiving a signal transmitted from the specific user equipment; and when the specific user equipment is not detected by the receiver, the transmitter may transmit the D2D signal using the first resource and the second resource. With this configuration, resources that can transmit the D2D signal can be increased.

A configuration unit may be included that receives the configuration information from a base station of the mobile communication system or the specific user equipment, and that stores the configuration information in the storage unit, wherein, upon receiving any other configuration information from the specific user equipment after receiving the configuration information from the base station, the configuration unit may overwrite the configuration information received from the base station with the other configuration information received from the specific user equipment. With this configuration, the configuration information received from the specific user equipment can be preferentially handled.

Furthermore, according to one or more embodiments of the invention, there is provided user equipment of a mobile communication system supporting D2D, the user equipment including a storage unit that retains information on a carrier used for D2D, the carrier being different from a carrier used for communication between a base station of the mobile communication system and the user equipment; and a transmitter that transmits a D2D signal using the carrier used for D2D.

With the above-described configuration, transmission of the D2D signal can be properly performed in the mobile communication system supporting D2D.

The information on the carrier used for D2D is, for example, information on a plurality of carriers for respective service types; and, when a D2D signal corresponding to a specific service type is to be transmitted, the transmitter transmits the D2D signal using, among the plurality of carriers, a carrier corresponding to the specific service type. With this configuration, a dedicated carrier for each service type can be used, so that transmission and reception of D2D signals can be efficiently performed.

The transmitter may transmit the D2D signal using transmission power configured without depending on pathloss between the base station of the mobile communication system and the user equipment. With this configuration, D2D signals can be transmitted with stable transmission power, regardless of the distance between the user equipment and the base station.

The user equipment may include a location information processor that determines, upon receiving location information from a specific device that is identifiable by the user equipment, whether the location information indicates a predetermined location, wherein, upon detecting that the location information indicates the predetermined location, the location information processor preferentially receives a signal transmitted from the specific device. With this configuration, the user equipment can preferentially receive a signal from the specific device.

Furthermore, the “unit” in the configuration of the above-described device may be replaced with “part,” “circuit,” “device,” and so forth.

The UE (which includes the UE-type RSU) described in the embodiment may have a configuration that is implemented by executing a program by a CPU (processor) in the UE (which includes the UE-type RSU) including the CPU and a memory; may have a configuration that is implemented by hardware provided with a logic for the process described in the embodiment, such as a hardware circuit; or may have a mixture of programs and hardware.

The eNB (which includes the eNB-type RSU) described in the embodiment may have a configuration that is implemented by executing a program by a CPU (processor) in the eNB (which includes the eNB-type RSU) including the CPU and a memory; may have a configuration that is implemented by hardware provided with a logic for the process described in the embodiment, such as a hardware circuit; or may have a mixture of programs and hardware.

Exemplary embodiments of the present invention are described above; however the disclosed invention is not limited to these embodiments. A person ordinarily skilled in the art will appreciate various variations, modifications, alternatives, replacements, and so forth. Specific examples of numerical values are used in the description in order to facilitate understanding of the invention. However, these numerical values are merely an example, and any other appropriate values may be used, except as indicated otherwise. The separations of the items in the above description are not essential to the present invention. Depending on necessity, subject matter described in two or more items may be combined and used, and subject matter described in an item may be applied to subject matter described in another item (provided that they do not contradict). A boundary of a functional unit or a processor in the functional block diagrams may not necessarily correspond to a boundary of a physical component. An operation by a plurality of functional units may be physically executed by a single component, or an operation of a single functional unit may be physically executed by a plurality of components. For the convenience of description, the base station and the user equipment are described by using the functional block diagrams; however, such devices may be implemented in hardware, software, or combinations thereof. The software to be executed by the processor included in the user equipment and the base station in accordance with the embodiment of the present invention may be stored in any appropriate storage medium, such as a random access memory (RAM), a flash memory, a read-only memory (ROM), an EPROM, an EEPROM, a register, a hard disk drive (HDD), a removable disk, a CD-ROM, a database, a server, and so forth.

### Supplements to the Embodiments

Reporting of information is not limited to the aspects/embodiments described in this specification, and may be performed by another method. For example, reporting of information may be implemented by physical layer signaling (e.g., DCI (Downlink Control Information)), UCI (Uplink Control Information)), higher layer signaling (e.g., RRC signaling, MAC signaling, broadcast information (MIB (Master Information Block), SIB (System Information Block)), other signals or a combination thereof. Furthermore, the RRC message may be referred to as RRC signaling. Furthermore, the RRC message may be, for example, an RRC connection setup (RRC Connection Setup) message, an RRC connection reconfiguration (RRC Connection Reconfiguration) message, and so forth.

The aspects/embodiments described in the specification can be applied to LTE (Long Term Evolution); LTE-A (LTE-Advanced); SUPER 3G; IMT-Advanced; 4G; 5G; FRA (Future Radio Access); W-CDMA®; GSM®; CDMA 2000; UMB (Ultra Mobile Broadband); IEEE 802.11 (Wi-Fi); IEEE 802.16 (WiMAX); IEEE 802.20; UWB (Ultra-Wide Band); Bluetooth®; a system that utilizes another suitable system and/or a next generation system evolved based on these.

The input/output information, etc., may be stored in a specific location (e.g., a memory), or may be managed by a management table. The input/output information, etc., may be overwritten, updated, or added. The output information, etc., may be deleted. The input information, etc. may be transmitted to another device.

The decision or determination may be performed by a value (0 or 1) represented by one bit; may be performed by a Boolean value (Boolean: true or false); or by numerical value comparison (e.g., a comparison with a predetermined value).

The information, signals, etc., described in the specification may be represented by using any of various different techniques. For example, the data, instruction, command, information, signal, bit, symbol, chip, etc., which may be referred to over the entire description above, may be represented by a voltage, an electric current, an electromagnetic wave, a magnetic field or magnetic particles, a light field or photons, or any combination thereof.

Note that the terms described in this specification and/or terms required for understanding the specification may be replaced with terms having the same or similar meanings. For example, a channel and/or a symbol may be a signal (signal). Furthermore, a signal may be a message.

The UE may be referred to, by a person skilled in the art, as a subscriber station; a mobile unit; a subscriber unit; a wireless unit; a remote unit; a mobile device; a wireless device; a wireless communication device; a remote device; a mobile subscriber station; an access terminal; a mobile terminal; a wireless terminal; a remote terminal; a handset; a user agent; a mobile client; a client; or some other suitable terms.

The order of the processing procedures, sequences, and so forth of the aspects/embodiment described in the specification may be re-arranged, provided that they do not contradict. For example, for the methods described in the specification, the elements of various steps are presented in an exemplary order, and are not limited to the specific order presented.

Each aspect/embodiment described in the specification may be used alone; may be used in combination; or may be used by switching depending on execution. Furthermore, reporting of predetermined information (e.g., reporting of “being X”) is not limited to the method of explicitly performing, and may be performed implicitly (e.g., not perform reporting of the predetermined information).

The terms “determine (determining)” and “decide (determining)” may encompass a wide variety of operations. The “determine” and “decide” may include, for example, “determine” and “decide” what is calculated (calculating), computed (computing), processed (processing), derived (deriving), investigated (investigating), looked up (looking up) (e.g., looked up in tables, databases, or other data structures), ascertained (ascertaining). Furthermore, the “determine” and “decide” may include deeming that “determination” and “decision” are made on reception (receiving) (e.g., receiving information), transmission (transmitting) (e.g., transmitting information), input (input), output (output), and access (accessing) (e.g., accessing data in a memory). Furthermore, the “determine” and “decide” may include deeming that “determination” and “decision” are made on what is resolved (resolving), selected (selecting), chosen (choosing), established (establishing), and compared (comparing). Namely, the “determine” and “decide” may include deeming that some operation is “determined” or “decided.”

The phrase “based on” used in this specification does not imply “based only on” unless explicitly stated otherwise. In other words, the phrase “based on” implies both “based only on” and “based at least on.”

The present invention is not limited to the above-described embodiments; and various variations, modifications, alternatives, replacements, and so forth are included in the present invention without departing from the spirit of the present invention.

### LIST OF REFERENCE SYMBOLS

RSU: rode-side unit

eNB: base station

UE: user equipment

101: signal transmitter

102: signal receiver

103: resource manager

104: access controller

105: location information processor

201: signal transmitter

202: signal receiver

203: resource manager

204: access controller

205: scheduler

206: location information processor

1001: processor

1002: memory

1003: storage

1004: communication device

1005: input device

1006: output device

1. A user equipment of a mobile communication system supporting Device-to-Device (D2D) communication, the user equipment comprising:
a memory coupled to a processor, that stores configuration information indicating information on a first resource with which transmission of a D2D signal by the user equipment is allowed and information on a second resource with which transmission of a D2D signal by an other user equipment is allowed, the other user equipment being a specific type of user equipment; and
a transmitter that transmits, based on the configuration information, the D2D signal using the first resource.

2. The user equipment according to claim 1, wherein the configuration information indicates a configuration of one or more uplink subframes and one or more downlink subframes in Time Division Duplexing (TDD),
wherein the D2D signal is transmitted by the user equipment through the one or more uplink subframes and the D2D signal is transmitted by the other user equipment through the one or more downlink subframes; or the D2D signal is transmitted by the user equipment through the one or more downlink subframes and the D2D signal is transmitted by the other user equipment through the one or more uplink subframes.

3. The user equipment according to claim 1, wherein the user equipment includes a receiver that detects the other user equipment by receiving a signal transmitted from the other user equipment,
wherein, when the other user equipment is not detected by the receiver, the transmitter transmits the D2D signal using the first resource and the second resource.

4. The user equipment according to claim 1, wherein the user equipment receives the configuration information from a base station of the mobile communication system or the other user equipment, and the processor stores the configuration information in the memory, and
wherein, upon receiving any other configuration information from the other user equipment after receiving the configuration information from the base station, the processor overwrites the configuration information received from the base station with the other configuration information received from the other user equipment.

5. A user equipment of a mobile communication system supporting Device-to-Device (D2D) communication, the user equipment comprising:
a memory coupled to a processor, that stores information on a carrier used for D2D, the carrier being different from a carrier used for communication between a base station of the mobile communication system and the user equipment; and
a transmitter that transmits a D2D signal using the carrier used for D2D.

6. The user equipment according to claim 5, wherein the information on the carrier used for D2D is information on a plurality of carriers for respective service types, and
wherein, when a D2D signal corresponding to a specific service type is to be transmitted, the transmitter transmits the D2D signal using, among the plurality of carriers, a carrier corresponding to the specific service type.

7. The user equipment according to claim 5, wherein the transmitter transmits the D2D signal using transmission power configured without depending on pathloss between the base station of the mobile communication system and the user equipment.

8. The user equipment according to claim 1, wherein the processor of the user equipment determines, upon receiving location information from a specific device that is identifiable by the user equipment, whether the location information indicates a predetermined location, and
wherein, upon detecting that the location information indicates the predetermined location, the processor preferentially receives a signal transmitted from the specific device.

9. A Device-to-Device (D2D) signal transmission method to be executed by a user equipment of a mobile communication system supporting D2D, the D2D signal transmission method comprising:
receiving, from a base station of the mobile communication system, configuration information indicating information on a first resource with which transmission of a D2D signal by the user equipment is allowed and information on a second resource with which transmission of a D2D signal by an other user equipment is allowed, the other user equipment being a specific type of user equipment; and
transmitting, based on the configuration information, the D2D signal using the first resource.

10. A Device-to-Device (D2D) signal transmission method to be executed by user equipment of a mobile communication system supporting D2D, the D2D signal transmission method comprising:
receiving information on a carrier used for D2D, the carrier being different from a carrier used for communication between a base station of the mobile communication system and the user equipment, from the base station; and
transmitting the D2D signal using the carrier used for D2D.

11. The user equipment according to claim 2, wherein the user equipment includes a receiver that detects the other user equipment by receiving a signal transmitted from the other user equipment,
wherein, when the other user equipment is not detected by the receiver, the transmitter transmits the D2D signal using the first resource and the second resource.

12. The user equipment according to claim 2, wherein the processor of the user equipment receives the configuration information from a base station of the mobile communication system or the other user equipment, and stores the configuration information in the memory, and
wherein, upon receiving any other configuration information from the other user equipment after receiving the configuration information from the base station, the processor overwrites the configuration information received from the base station with the other configuration information received from the other user equipment.

13. The user equipment according to claim 3, wherein the processor of the user equipment receives the configuration information from a base station of the mobile communication system or the other user equipment, and stores the configuration information in the memory, and
wherein, upon receiving any other configuration information from the other user equipment after receiving the configuration information from the base station, the processor overwrites the configuration information received from the base station with the other configuration information received from the other user equipment.

14. The user equipment according to claim 6, wherein the transmitter transmits the D2D signal using transmission power configured without depending on pathloss between the base station of the mobile communication system and the user equipment.

15. The user equipment according to claim 2, wherein the processor of the user equipment determines, upon receiving location information from a specific device that is identifiable by the user equipment, whether the location information indicates a predetermined location, and
wherein, upon detecting that the location information indicates the predetermined location, the processor preferentially receives a signal transmitted from the specific device.

16. The user equipment according to claim 3, wherein the processor of the user equipment determines, upon receiving location information from a specific device that is identifiable by the user equipment, whether the location information indicates a predetermined location, and
wherein, upon detecting that the location information indicates the predetermined location, the processor preferentially receives a signal transmitted from the specific device.

17. The user equipment according to claim 4, wherein the processor of the user equipment determines, upon receiving location information from a specific device that is identifiable by the user equipment, whether the location information indicates a predetermined location, and
wherein, upon detecting that the location information indicates the predetermined location, the processor preferentially receives a signal transmitted from the specific device.

18. The user equipment according to claim 5, wherein the processor of the user equipment determines, upon receiving location information from a specific device that is identifiable by the user equipment, whether the location information indicates a predetermined location, and
wherein, upon detecting that the location information indicates the predetermined location, the processor preferentially receives a signal transmitted from the specific device.

19. The user equipment according to claim 6, wherein the processor of the user equipment determines, upon receiving location information from a specific device that is identifiable by the user equipment, whether the location information indicates a predetermined location, and
wherein, upon detecting that the location information indicates the predetermined location, the processor preferentially receives a signal transmitted from the specific device.
